(19) United States
(12) Patent Application Publication
(10) Pub. No.: US 2026/0111657 A1
(43) Pub. Date: Apr. 23, 2026

(54) METHOD AND SYSTEM FOR AUTOMATICALLY DETECTING ERRORS IN INDUSTRIAL PLANT CONFIGURATION TABLES

(71) Applicant: Siemens Aktiengesellschaft, München (DE)

(72) Inventor: Martin Ringsquandl, Raubling (DE)

(21) Appl. No.: 19/158,997

(22) PCT Filed: Feb. 26, 2024
(86) PCT No.: PCT/EP2024/054819

§ 371 Date: Aug. 22, 2025

(30) Foreign Application Priority Data
Feb. 28, 2023 (EP) 23159003.5

(51) Int. Cl. G06F 40/18; G06F 16/353; G06F 40/284

(52) U.S. Cl. CPC G06F 40/18; G06F 16/353; G06F 40/284

(57) ABSTRACT

For automatically detecting errors in industrial plant configuration tables (CT), a table encoder (TE) is trained to estimate an estimated probability that the cells in the tables contain an error. According to an embodiment, the table encoder is initially trained with a set of configuration tables. An Active Learning Query Strategy (ALQS) selects candidate cells (CC) from the set of configuration tables with a mixed strategy combining uncertainty sampling with a penalty for picking multiple candidate cells from the same configuration table. A user interface receives labeled cells (LC), wherein the labeled cells contain the candidate cells as well as labels indicating whether the candidate cells are erroneous. A training component (TC) performs gradient updates (GU) on the table encoder, using the labeled cells. As a result, the table encoder is re-trained after each user interaction to become a table token classification model. Using active learning, which is novel with regard to token classification in tabular data, allows to reduce the required amount of labeled data efficiently. The Active Learning Query Strategy balances uncertainty versus diversity and ensures that the candidate cells are selected from a diverse range of configuration tables. This embodiment provides a novel active learning workflow for tabular data and deep machine learning models. Furthermore, this embodiment saves experts time in annotating cells in configuration tables.

### CROSS-REFERENCE TO RELATED APPLICATIONS

This application is a national stage of PCT Application No. PCT/EP2024/054819, having a filing date of Feb. 26, 2024, which claims priority to EP Application No. 23159003.5, having a filing date of Feb. 28, 2023, the entire contents both of which are hereby incorporated by reference.

### FIELD OF TECHNOLOGY

The following relates to a method and system for automatically detecting errors in industrial plant configuration tables.

### BACKGROUND

Ensuring correct configuration of plant equipment is one of the main tasks of plant engineers. However, configuration data of industrial plants is often maintained with low quality. One of the main problems is that engineers manually enter critical information about plant equipment and processes in collaborative spreadsheets. This leads to incorrect values due to human errors, false auto-correction, etc. Especially when new equipment is introduced, configuration values typically are copy-pasted from existing configuration entries, e.g., from the most similar machine, which now results in error propagation.

Typically, such spreadsheets are roughly organized in tabular form, where each row represents an equipment, and each column represents some property of the equipment.

Configuration data is usually entered and corrected manually in these spreadsheets.

NASHAAT MONA NASHAATA@UALBERTA CA ET AL: “TabReformer: Unsupervised Representation Learning for Erroneous Data Detection”, ACM/IMS TRANSACTIONS ON DATA SCIENCE, ACMPUB27, NEW YORK, NY, vol. 2, no. 3, 17 May 2021 (2021-05-17), pages 1-29, XP058610994, ISSN: 2691-1922, DOI: 10.1145/3447541, discloses a software tool called TabReformer allowing data error detection in data tables.

US 2022/230476 A1 discloses data cleansing in a table obtained from time series data measured by sensors in an industrial plant.

### SUMMARY

According to embodiments of the method for automatically detecting errors in industrial plant configuration tables, the following operations are performed by components, wherein the components are hardware components and/or software components executed by one or more processors:
estimating, by a trained table encoder processing a configuration table,
   wherein the configuration table contains a header row and body rows,
   wherein each body row contains body cells and corresponds to an entity of an industrial plant,
   wherein each column of the table corresponds to a configuration property of the respective entities,
   wherein the header row contains header cells naming the respective properties,
   wherein the body cells contain tokens,
   wherein the table encoder (TE) is implemented with a token classification model that uses a tabular language model to obtain latent representations of the tokens, and
   wherein the tabular language model has a token classification head on top, for each body cell and/or for each token in that body cell, an error probability value, which gives an estimated probability that the cell and/or the token contains an error, and
comparing the error probability value for each body cell and/or for each token in that body cell with a given threshold, and if the error probability value is above the given threshold, detecting that the body cell is erroneous.

In embodiments, the system for automatically detecting errors in industrial plant configuration tables comprises the following components:
a table encoder, trained for processing a configuration table,
   wherein the configuration table contains a header row and body rows,
   wherein each body row contains body cells and corresponds to an entity of an industrial plant,
   wherein each column of the table corresponds to a configuration property of the respective entities,
   wherein the header row contains header cells naming the respective properties,
   wherein the body cells contain tokens,
   wherein the table encoder (TE) is implemented with a token classification model that uses a tabular language model to obtain latent representations of the tokens, and
   wherein the tabular language model has a token classification head on top, and estimating for each body cell and/or for each token in that body cell, an error probability value, which gives an estimated probability that the cell and/or the token contains an error, and
a comparator, configured for comparing the error probability value for each body cell and/or for each token in that body cell with a given threshold, and if the error probability value is above the given threshold, detecting that the body cell is erroneous.

The following advantages and explanations are not necessarily the result of the object of the independent claims. Rather, they may be advantages and explanations that only apply to certain embodiments or variants.

In connection with embodiments of the invention, unless otherwise stated in the description, the terms “training”, “generating”, “computer-aided”, “calculating”, “determining”, “reasoning”, “retraining” and the like relate to actions and/or processes and/or processing steps that change and/or generate data and/or convert the data into other data, the data in particular being or being able to be represented as physical quantities, for example as electrical impulses.

The term “computer” should be interpreted as broadly as possible, in particular to cover all electronic devices with data processing properties. Computers can thus, for example, be personal computers, servers, clients, programmable logic controllers (PLCs), handheld computer systems, pocket PC devices, mobile radio devices, smartphones, or any other communication devices that can process data with computer support, for example processors or other electronic devices for data processing. Computers can in particular comprise one or more processors and memory units.

In connection with embodiments of the invention, a “memory”, “memory unit” or “memory module” and the like can mean, for example, a volatile memory in the form of random-access memory (RAM) or a permanent memory such as a hard disk or a Disk.

In embodiments, the method and system, or at least some of their embodiments, allow for automatically finding cells in existing configuration tables for industrial plant equipment that contain errors. As a result, the table encoder, as a deep learning model, can act as a data quality guard, improving the overall configuration data quality over time.

An embodiment of the method comprises the additional operations of outputting, by a user interface, the erroneous body cell, and receiving, by the user interface, a corrected value for the erroneous body cell.

With this embodiment, pre-existing configuration tables can be quickly corrected, as the embodiment automatically finds erroneous cells and shows them to a user for correction.

Another embodiment of the method comprises the additional operations of generating different versions of the configuration table, in particular by filling, in each version, the erroneous cell with a value from another cell in the same column of the configuration table, estimating, by the trained table encoder, for each version an error probability value for the filled cell, and choosing the version with the lowest error probability value.

According to this embodiment, the table encoder identifies the best correction for the erroneous cell based on other entries in the same configuration table, thereby implementing an automated correction mechanism.

Yet another embodiment of the method comprises the additional operations of receiving, by a user interface, at least one entry for a new row to the configuration table, generating different versions of the configuration table by filling an empty cell in the new row with different values, in particular with random values or with values from other cells in the respective column of the configuration table, estimating, by the trained table encoder, for each version an error probability value for the filled cell, and choosing the version with the lowest error probability value.

According to this embodiment, configuration properties of new plant equipment are automatically predicted by the table encoder.

In an embodiment of the method, the tabular language model is implemented with a TaBert or TURL architecture.

In an embodiment of the method, the table encoder is initially trained with the operations of
providing, by a database, a set of configuration tables,
extracting, by a spreadsheet pre-processor, tokenized table cells from each configuration table, and
iteratively performing the following operations:
   processing, by the table encoder, the tokenized table cells and estimating for each tokenized table cell an error probability value,
   selecting, by an Active Learning Query Strategy, candidate cells from the set of configuration tables with a mixed strategy combining uncertainty sampling with a penalty for picking multiple candidate cells from the same configuration table,
   outputting, by a user interface, the candidate cells,
   receiving, by the user interface, labeled cells, wherein the labeled cells contain the candidate cells as well as labels indicating whether the candidate cells are erroneous, and
   performing, by a training component, gradient updates on the table encoder, using the labeled cells.

As a result, the table encoder is re-trained after each user interaction, until the table encoder is fully trained and usable as a table token classification model. Using active learning, which is novel with regard to token classification in tabular data, allows to reduce the required amount of labeled data efficiently. The Active Learning Query Strategy balances uncertainty versus diversity and ensures that the candidate cells are selected from a diverse range of configuration tables due to the penalty. The Active Learning Query Strategy is a mixture between selecting the most uncertain cells while maintaining diversity.

In other words, this embodiment provides a novel active learning workflow for tabular data and deep machine learning models. The employed query strategy balances uncertainty versus diversity, thus ensuring good performance with a limited amount of labels. Furthermore, the embodiment saves experts time in annotating cells in configuration tables.

In an embodiment of the method, the uncertainty sampling is implemented by selecting candidate cells that have maximum entropy given the current training state of the table encoder, and the penalty is implemented by a penalty weight that increases with the number of candidate cells being selected from the same configuration table.

An embodiment of the system provides an active learning system, comprising
a database, storing a set of configuration tables,
a spreadsheet pre-processor, configured for extracting tokenized table cells from each configuration table,
the system, wherein the table encoder is configured for processing the tokenized table cells and estimating for each tokenized table cell an error probability value,
an Active Learning Query Strategy component, configured for selecting candidate cells from the set of configuration tables with a mixed strategy combining uncertainty sampling with a penalty for picking multiple candidate cells from the same configuration table,
a user interface, configured for
   outputting the candidate cells, and
   receiving labeled cells, wherein the labeled cells contain the candidate cells as well as labels indicating whether the candidate cells are erroneous, and
a training component, configured for performing gradient updates on the table encoder, using the labeled cells.

The computer program product (non-transitory computer readable storage medium having instructions, which when executed by a processor, perform actions) comprises instructions which, when the program is executed by a computer, cause the computer to carry out the method.

The provisioning device stores and/or provides the computer program product.

### BRIEF DESCRIPTION

Some of the embodiments will be described in detail, with references to the following Figures, wherein like designations denote like members, wherein:

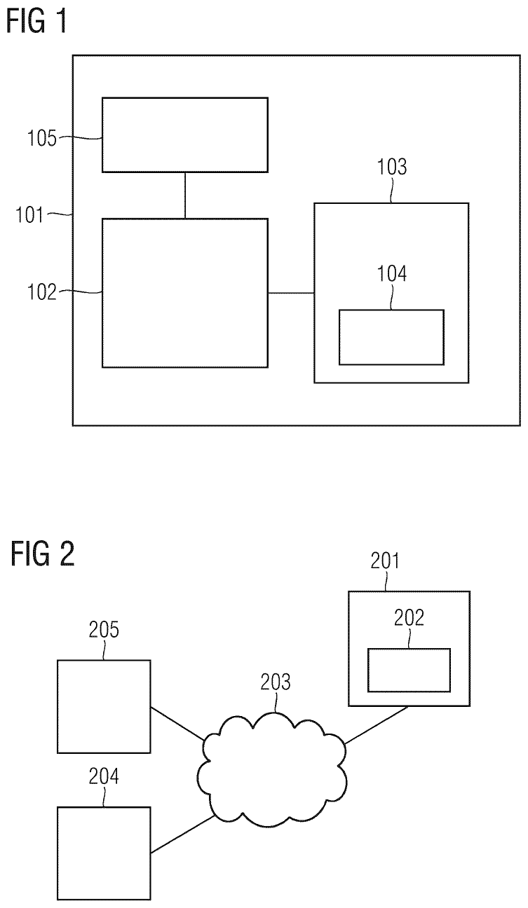

FIG. 1 shows a first embodiment;

FIG. 2 shows another embodiment;

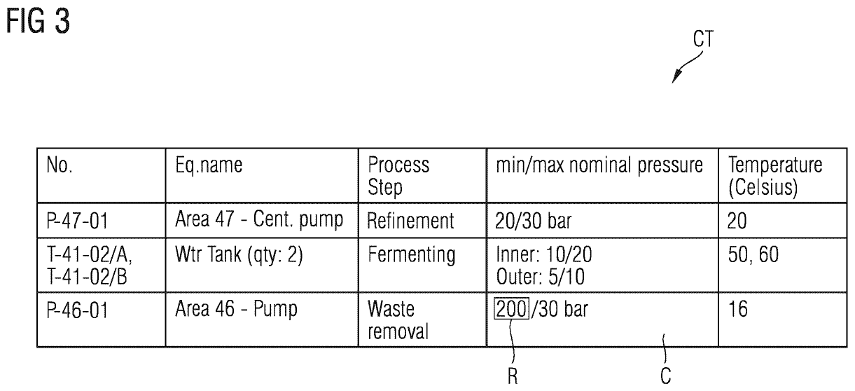

FIG. 3 shows an example configuration table CT, wherein a row for new equipment shows a highlighted error;

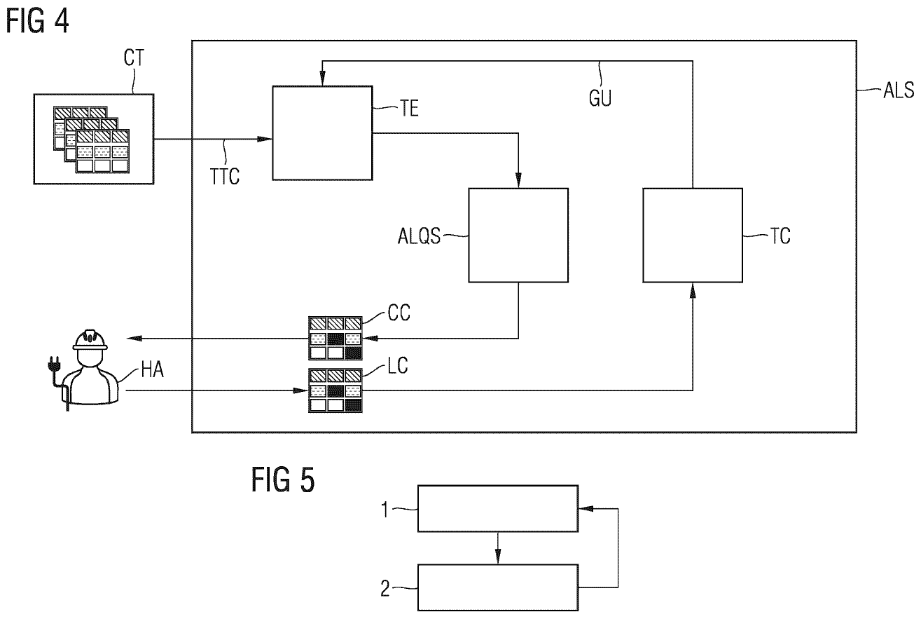

FIG. 4 shows an embodiment of an active learning system ALS; and

FIG. 5 shows a flowchart of a possible exemplary embodiment of a method for automatically detecting errors in industrial plant configuration tables.

### DETAILED DESCRIPTION

In the following description, various aspects of embodiments of the present invention and embodiments thereof will be described. However, it will be understood by those skilled in the art that embodiments may be practiced with only some or all aspects thereof. For purposes of explanation, specific numbers and configurations are set forth in order to provide a thorough understanding. However, it will also be apparent to those skilled in the art that the embodiments may be practiced without these specific details.

The described components can each be hardware components or software components. For example, a software component can be a software module such as a software library; an individual procedure, subroutine, or function; or, depending on the programming paradigm, any other portion of software code that implements the function of the software component. A combination of hardware components and software components can occur, in particular, if some of the effects according to embodiments of the invention are exclusively implemented by special hardware (e.g., a processor in the form of an ASIC or FPGA) and some other part by software.

Yin P., Neubig G., Yih W., Riedel S., TABERT: Pretraining for Joint Understanding of Textual and Tabular Data, A C L 2020, discloses the TaBERT transformer architecture. The entire contents of that document are incorporated herein by reference.

Deng et al., TURL: table understanding through representation learning, VLDB 2020, discloses the TURL transformer architecture. The entire contents of that document are incorporated herein by reference.

FIG. 1 shows one sample structure for computer-implementation of embodiments of the invention which comprises:
(101) computer system
(102) processor
(103) memory
(104) computer program (product)
(105) user interface

In an embodiment of the invention the computer program 104 comprises program instructions for carrying out embodiments of the invention. The computer program 104 is stored in the memory 103 which renders, among others, the memory 103 and/or its related computer system 101 a provisioning device for the computer program 104. The computer system 101 may carry out embodiments of the invention by executing the program instructions of the computer program 104 by the processor 102. Results of embodiments of the invention may be presented on the user interface 105. Alternatively, they may be stored in the memory 103 or on another suitable means for storing data.

FIG. 2 shows another sample structure for computer-implementation of embodiments of the invention which comprises:
(201) provisioning device
(202) computer program (product)
(203) computer network/Internet
(204) computer system
(205) mobile device/smartphone

In this embodiment the provisioning device 201 stores a computer program 202 which comprises program instructions for carrying out embodiments of the invention. The provisioning device 201 provides the computer program 202 via a computer network/Internet 203. By way of example, a computer system 204 or a mobile device/smartphone 205 may load the computer program 202 and carry out embodiments of the invention by executing the program instructions of the computer program 202.

In a variation of this embodiment, the provisioning device 201 is a computer-readable storage medium, for example a SD card, that stores the computer program 202 and is connected directly to the computer system 204 or the mobile device/smartphone 205 in order for it to load the computer program 202 and carry out embodiments of the invention by executing the program instructions of the computer program 202.

The embodiments shown in FIGS. 3 to 5 can be implemented with a structure as shown in FIG. 1 or FIG. 2.

The embodiments described in the following can automatically predict configuration properties of new plant equipment or suggest corrections for erroneous existing ones.

FIG. 3 shows an example configuration of new equipment with a highlighted error. The depicted configuration table CT gives an example of a simple equipment configuration spreadsheet. It can be seen that for example equipment types like “pump” and “tank”, a “nominal pressure” is given as a configuration property. An error, marked with a surrounding rectangle R, occurred when copying entries to a new equipment P-46-01 in the third row. The respective cell C is suspicious since the min nominal pressure value is higher than the max nominal pressure value. The goal is to automatically find these cells and to show them to a user for correction.

The following embodiments assume that the configuration table CT is an entity table, where each row corresponds to an entity (e.g., a machine) and each column corresponds to a property of that entity.

The data source of embodiments of the system is a collection of spreadsheet documents D={Tᵢ}, and each spreadsheet represents an entity table Tᵢ=(H,B) as a tuple. The table header H={h₁, h₂, . . . , hₘ} is a set of m header cells. The table body B={b_{1,1}, b_{1,2}, . . . , b_{n,m}} is the set of table body cells having n rows and m columns. Each body cell b_{i,j}=(w₁, w₂, . . . , wₜ) and header cell hᵢ=(w₁, w₂, . . . , wₜ) is also a sequence of words.

According to the current embodiment, an error prediction is phrased as a machine learning classification problem for every word in either body or cell:

$$f ( w ) = P ( y \vert w ) , y ∈ \{ True , False \} ( error , no error ) .$$

Deep learning models require large amounts of labeled data.

The problem of applying deep learning in this context is that labels are typically not available and obtaining labels from experts is very expensive. In other words, labels are scarce.

The following embodiments describe different approaches on how to use active learning to reduce the amount of labeled data, with the goal of providing label-efficient deep learning to correct errors in plant configuration tables. Implementing active learning in tabular data is not an obvious choice as traditional active learning approaches do not work well for deep learning models on tables, i.e., Table Language Models (TaLMs).

FIG. 4 shows an embodiment of an active learning system ALS, which implements
a) an overall Active Learning Workflow, and
b) an Active Learning Query Strategy ALQS.

As input, the active learning system ALS receives a collection of configuration tables CT, for example, a set of spreadsheet documents.

The output of the active learning system ALS is a trained table encoder TE providing a trained table token classification model.

The token classification model (provided and implemented by the table encoder TE) can be any Tabular Language Model (TaLM) to obtain latent representations of tokens within table cells with a token classification head on top. This is state-of-the-art and can be implemented, for example, with a TaBERT or TURL architecture described in the references cited above. The token classification head is part of the table encoder TE.

In order to train the table encoder TE, tokenized table cells TTC are extracted from the configuration tables CT. This extraction step is performed, for example, by a dedicated spreadsheet preprocessor that transforms the configuration tables CT into a numerical tensor representation. For example, the spreadsheet pre-processor outputs a sequence of cell tokens for each cell in each configuration table CT. Tokenization of each cell can be done in different ways, either on character-, word- or word-piece (token) level.

The table encoder TE includes, for example, a token encoder, which is a neural network that produces a single latent representation for each sequence of cell tokens. For example, LSTMs or transformer models could be used here. The latent representation of the sequence of cell tokens is now the cell representation.

The latent representations of the cells are then processed by multiple layers of a table transformer (e.g., a TaBERT or TURL transformer architecture) with a multi-head self-attention that allows cell embeddings to pass neural messages.

The table transformer is also part of the table encoder TE. It computes and outputs latent token representations for the cells in the configuration tables CT. The latent token representations are then processed by a token classification head, outputting for each token an error probability value, which gives an estimated probability that the token contains an error.

The Active Learning Query Strategy ALQS shown in FIG. 4 is discussed in the following. Active learning for token classification in tabular data needs special characteristics compared to token classification in natural language sentences. Every cell can be seen as a sentence, and they all depend on each other within the same table.

According to the current embodiment, candidate cells CC are presented to a human annotator HA for labeling as shown in FIG. 4. It is desirable to select candidate cells CC which have the highest uncertainty of containing an error (close to equal probability of yes/no), e.g., the most ambiguous or borderline cases. The human annotator HA then labels the candidate cells CC either with the label “yes cell contains error” or with the label “no cell does not contain any error”, thus providing labeled cells LC to the active learning system ALS.

Given a pool of unlabeled table tokens D_{U} and a loss function, e.g., binary cross entropy, l_{BCE}, active learning wants to find a subset D_{S}∪D_{U} with restricted budget |D_{S}|<budget. The human annotator HA as shown in FIG. 4 should now label D_{S}. So, ideally D_{S} should be such that argmin_{D}_{_{S}} [symbol] _{(x,y)˜D} [l_{BCE}(f_{D}_{_{S}}(x),y)]. Here f_{D}_{_{S}} means the token classification model trained on data D_{S} and D is the unknown true data distribution.

The labeled cells LC are fed back to a training component TC, which performs gradient updates GU on the table encoder TE. As a result, the table encoder TE is re-trained after each interaction of the human annotator HA with the active learning system ALS.

Traditional query strategies are based on the notion of uncertainty sampling, where the subset D_{S} is filled one-by-one with

$$arg {max}_{x ∈ {D}_{U}} [ - {\sum }_{i = 1} {f}_{{D}_{t}} ( x , {y}_{k} ) * log ( {f}_{{D}_{t}} ( x , {y}_{k} ) ) ] .$$

In other words, the next unlabeled instance to choose is the one that has maximum entropy given the current classification at time step t model h_{D}_{ₜ}.

For deep learning models this strategy is sub-optimal since it tends to select very similar instances into D_{S}. However, deep learning models are trained in a batch fashion, i.e., D_{S} is a batch for one training round and therefore this batch should be as diverse as possible to get a maximum performance gain.

For deep learning models on tables the current embodiment uses the following strategy as the active learning query strategy ALQS:

| | |
|---|---|
| 1. | Ds = Ø |
| 2. | Dcand = Ø |
| 3. | For each table T_{z} |
| | a. For each row T_{z[:,c]} |
| | i. Find the maximum uncertain cell: |
| | $arg {max}_{{b}_{i , j ∈ {T}_{z} [ : ; c ]}} \frac{1}{\vert {b}_{i , j} \vert} score ( {b}_{i , j} ) ,$ |
| | score(cell) = Σ_{w∈cell} − Σₖf_{D}_{ₜ} (w, yₖ) * log (f_{D}_{ₜ} (w, yₖ)) |
| | ii. D_{cand} = D_{cand} ∪ {b_{i,j}} |
| 4. | For each cell in the sorted D_{cand} |
| | a. If \|D_{S}\| < budget: D_{S} = D_{S} ∪ {w ∈ b_{i,j}} |
| | b. score′ = score(cell) * α^{count(tab(cell),D}^{_{S}}⁾ |
| | c. sort D_{cand}again w.r.t. score′ |

The active learning query strategy ALQS ensures that the candidate cells CC are selected from a diverse set of tables due to the penalty weight α<I that increases with the number of cells from the same table in D_{S}. Therefore, it is a mixture between selecting the most uncertain cells while maintaining diversity.

The trained table encoder TE can then be used for different industrial applications, as will be described in the following.

In a first industrial application embodiment, the table encoder TE is used for automatically finding cells in existing configuration tables for industrial plant equipment that contain errors. If the probability value that the table encoder TE outputs for a cell is above a given threshold, then that cell is prompted to a user for correction. In this way, pre-existing configuration tables can be quickly corrected.

In a second industrial application embodiment, the table encoder TE is used not only to find erroneous cells in a configuration table, but to also suggest corrections for their erroneous values. In order to achieve this, a set of plausible candidate values are input into the table encoder TE. The best candidate is the one for which the table encoder TE outputs the lowest error probability. For example, different versions of the configuration table are created, and for each version, the erroneous cell is filled with values taken from another cell in the same column of the configuration table. Each version is then processed by the table encoder TE. The best candidate among these versions is the one for which the table encoder TE outputs the lowest error probability.

In a third industrial application embodiment, configuration properties of new plant equipment are automatically predicted by the table encoder TE. In order to achieve this, a set of plausible candidate property values are input into the table encoder TE. The best candidate among these versions is the one for which the table encoder TE outputs the lowest error probability. For example, different versions of a configuration table are created by adding a new row for a new equipment and filling it with plausible values. Each version is then processed by the table encoder TE. The best candidate among these versions is the one for which the table encoder TE outputs the lowest error probability.

FIG. 5 shows a flowchart of a possible exemplary embodiment of a method for automatically detecting errors in industrial plant configuration tables, wherein the following operations are performed by components, and wherein the components are hardware components and/or software components executed by one or more processors:

In an estimating operation 1, a trained table encoder processes a configuration table, wherein the configuration table contains a header row and body rows, wherein each body row contains body cells and corresponds to an entity of an industrial plant, wherein each column of the table corresponds to a configuration property of the respective entities, wherein the header row contains header cells naming the respective properties, and wherein the body cells contain tokens. The trained table encoder estimates for each body cell and/or for each token in that body cell, an error probability value, which gives an estimated probability that the cell and/or the token contains an error.

In a comparing operation 2, the error probability value for each body cell and/or for each token in that body cell is compared with a given threshold, and if the error probability value is above the given threshold, it is detected that the body cell is erroneous.

For example, the method can be executed by one or more processors. Examples of processors include a microcontroller or a microprocessor, an Application Specific Integrated Circuit (ASIC), or a neuromorphic microchip, in particular a neuromorphic processor unit. The processor can be part of any kind of computer, including mobile computing devices such as tablet computers, smartphones or laptops, or part of a server in a control room or cloud.

The above-described method may be implemented via a computer program product including one or more computer-readable storage media having stored thereon instructions executable by one or more processors of a computing system. Execution of the instructions causes the computing system to perform operations corresponding with the acts of the method described above.

The instructions for implementing processes or methods described herein may be provided on non-transitory computer-readable storage media or memories, such as a cache, buffer, RAM, FLASH, removable media, hard drive, or other computer readable storage media. Computer readable storage media include various types of volatile and non-volatile storage media. The functions, acts, or tasks illustrated in the figures or described herein may be executed in response to one or more sets of instructions stored in or on computer readable storage media. The functions, acts or tasks may be independent of the particular type of instruction set, storage media, processor or processing strategy and may be performed by software, hardware, integrated circuits, firmware, micro code and the like, operating alone or in combination. Likewise, processing strategies may include multiprocessing, multitasking, parallel processing and the like.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A computer implemented method for automatically detecting errors in industrial plant configuration tables, wherein the following operations are performed by components, and wherein the components are hardware components and/or software components executed by one or more processors, the method comprising:
estimating, by a trained table encoder processing a configuration table,
wherein the configuration table contains a header row and body rows,
wherein each body row contains body cells and corresponds to an entity of an industrial plant,
wherein each column of the configuration table corresponds to a configuration property of the respective entities,
wherein the header row contains header cells naming the respective properties,
wherein the body cells contain tokens,
wherein the trained table encoder is implemented with a token classification model that uses a tabular language model to obtain latent representations of the tokens, and
wherein the tabular language model has a token classification head on top, for each body cell and/or for each token in that body cell, an error probability value, which gives an estimated probability that the cell and/or the token contains an error, and
comparing the error probability value for each body cell and/or for each token in that body cell with a given threshold, and if the error probability value is above the given threshold, detecting that the body cell is erroneous.

2. The method of claim 1, further comprising
outputting, by a user interface, the erroneous body cell, and
receiving, by the user interface, a corrected value for the erroneous body cell.

3. The method of claim 1, further comprising:
generating different versions of the configuration table, by filling, in each version, the erroneous cell with a value from another cell in the same column of the configuration table,
estimating, by the trained table encoder, for each version an error probability value for the filled cell, and
choosing the version with the lowest error probability value.

4. The method of claim 1, further comprising:
receiving, by a user interface, at least one entry for a new row to the configuration table,
generating different versions of the configuration table by filling an empty cell in the new row with different values, random values, or with values from other cells in the respective column of the configuration table,
estimating, by the trained table encoder, for each version an error probability value for the filled cell, and
choosing the version with the lowest error probability value.

5. The method according to claim 1, wherein the tabular language model is implemented with a TaBert or TURL architecture.

6. The method according to claim 1,
wherein the trained table encoder is initially trained by:
providing, by a database, a set of configuration tables,
extracting, by a spreadsheet pre-processor, tokenized table cells from each configuration table, and
iteratively performing the following operations:
processing, by the trained table encoder, the tokenized table cells and estimating for each tokenized table cell an error probability value,
selecting, by an Active Learning Query Strategy, candidate cells from the set of configuration tables with a mixed strategy combining uncertainty sampling with a penalty for picking multiple candidate cells from the same configuration table,
outputting, by a user interface, the candidate cells,
receiving, by the user interface, labeled cell, wherein the labeled cells contain the candidate cells as well as labels indicating whether the candidate cells are erroneous, and
performing, by a training component, gradient updates on the trained table encoder, using the labeled cells.

7. The method according to claim 6,
wherein the uncertainty sampling is implemented by selecting candidate cells that have maximum entropy given a current training state of the trained table encoder, and
wherein a penalty is implemented by a penalty weight that increases with a number of candidate cells being selected from the same configuration table.

8. A system for automatically detecting errors in industrial plant configuration tables, comprising:
a table encoder, trained for processing a configuration table,
wherein the configuration table contains a header row and body rows,
wherein each body row contains body cells and corresponds to an entity of an industrial plant,
wherein each column of the configuration table corresponds to a configuration property of the respective entities,
wherein the header row contains header cells naming the respective properties,
wherein the body cells contain tokens,
wherein the table encoder is implemented with a token classification model that uses a tabular language model to obtain latent representations of the tokens, and
wherein the tabular language model has a token classification head on top,
and estimating for each body cell and/or for each token in that body cell, an error probability value, which gives an estimated probability that the cell and/or the token contains an error, and
a comparator, configured for comparing the error probability value for each body cell and/or for each token in that body cell with a given threshold, and if the error probability value is above the given threshold, detecting that the body cell is erroneous.

9. An active learning system, comprising:
a database, storing a set of configuration tables,
a spreadsheet pre-processor, configured for extracting tokenized table cells from each configuration table,
the system according to claim 8, wherein the table encoder is configured for processing the tokenized table cells and estimating for each tokenized table cell an error probability value,
an Active Learning Query Strategy component, configured for selecting candidate cells from the set of configuration tables with a mixed strategy combining uncertainty sampling with a penalty for picking multiple candidate cells from the same configuration table,
a user interface, configured for
outputting the candidate cells, and
receiving labeled cells, wherein the labeled cells contain the candidate cells as well as labels indicating whether the candidate cells are erroneous, and
a training component, configured for performing gradient updates on the table encoder, using the labeled cells.

10. A computer program product, comprising a computer readable hardware storage device having computer readable program code stored therein, said program code executable by a processor of a computer system to implement a method according to claim 1.

11. A provisioning device for the computer program product according to claim 10, wherein the provisioning device stores and/or provides the computer program product.
